(19) United States
(12) Patent Application Publication
(10) Pub. No.: US 2009/0200876 A1
(43) Pub. Date: Aug. 13, 2009

(54) SYNCHRONOUS RELUCTANCE MOTOR

(75) Inventor: Shin Kusase, Oobu-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/367,688

(22) Filed: Feb. 9, 2009

(30) Foreign Application Priority Data
Feb. 12, 2008 (JP) 2008-030034

(51) Int. Cl. H02K 37/04

(52) U.S. Cl. 310/46

(57) ABSTRACT

In a synchronous reluctance motor composed of a stator core and a rotor core, convex grooves are formed along q-axis in an outer circumferential surface of the rotor core. A rotor coil is wound in the convex grooves. Applying a direct current to the rotor coil generates a torque of a current magnetic flux Φi in addition to a reluctance torque. Each convex groove formed at the q-axis prevents decreasing the reluctance torque. The rotor coil has a cross sectional shape in a diametrical direction of the rotor coil so that the rotor coil has a maximum diametrical width at the q-axis position, and the diametrical width of the rotor coil is gradually decreased according to the distance from the q-axis position.

### CROSS-REFERENCE TO RELATED APPLICATION

This application is related to and claims priority from Japanese Patent Application No. 2008-30034 filed on Feb. 12, 2008, the contents of which are hereby incorporated by reference.

### BACKGROUND OF THE INVENTION

1. Field of the Invention

The present invention relates to a synchronous reluctance motor having an improved structure of a rotor equipped with a rotor coil to form a direct current magnetic flux.

2. Description of the Related Art

There are well known permanent magnet type synchronous motors (PM) having a rotor equipped with permanent magnets to generate magnetic flux, synchronous motors (FCSM) having a rotor with field coils to generate magnetic flux, and reluctance motors (RM) having a rotor with projecting magnetic poles to generate a reluctance torque. Those motors are widely used in various application fields. In particular, PM has a high efficiency because of being with no power loss occurs when it is generating a magnetic flux. However, a PM needs to control the magnetic flux to be decreased, further to have an anti-centrifugal force function and anti-vibration function for the permanent magnets mounted on the rotor during a high speed rotation of the rotor PM further needs to have magnets made of expensive rare earth metal having a poor anti-heat capability and the place of production for which are limited.

PM can be divided into two types, surface permanent magnet motors (SPM) and Interior permanent magnets (IPM). In SPM, magnets are placed on the surface of the rotor of SPM. In IPM, magnets are embedded in the rotor. IPM uses a reluctance torque in addition to a magnetic flux torque.

On the other hand, RM is divided into synchronous reluctance motors (SynRM or SyRM) and switched reluctance motors (SRM). In SynRM, the rotor having projecting magnetic poles rotates in synchronization with a sine-curve rotary magnetic field which is generated by the stator. In SRM, the rotor having projecting magnetic poles rotates, like a stepping motor, by switching a magnetic field generated by the stator. It is known that SynRM has a low noise and low vibration when compared with SRM.

FIG. 5 is a schematic cross section of a conventional synchronous reluctance motor in its diameter direction. FIG. 6 is a schematic cross section of another conventional synchronous reluctance motor in its diameter direction. As shown in FIG. 5, Japanese patent laid open publication No. JP 2006-121821 has disclosed SynRM having flux barriers (also referred to as “slits”) with a five-layer structure connected between a pair of d-axis separated by electrical angle Π to each other This structure of SynRM makes a d-axis inductance Ld of the rotor which is greater than a q-axis inductance Lq, and as a result, increases the reluctance torque (=(Ld−Lq)Id·Lq).

On the other hand, as shown in FIG. 6, Japanese patent laid open publication No. H-11 89193 has disclosed another structure of SynRM having flux barriers (also referred to as “cslits”) with a four-layer structure connected between a pair of d-axis separated by electrical angle Π to each other. This structure enables the d-axis inductance Ld of the rotor to be larger than the q-axis inductance Lq, and as a result increases the reluctance torque (=(Ld−Lq)Id·Lq).

However, although having the features described above, the conventional SynRM has a low motor efficiency because of causing a current loss when generating a magnetic field, and also has a large size per torque.

### SUMMARY OF THE INVENTION

It is an object of the present invention to provide a synchronous reluctance motor with an improved motor efficiency having an improved structure to generate a torque without using magnets involving the drawback described above in the related art section.

To achieve the above purposes, the present invention provides a synchronous reluctance motor having a stator and a rotor core. The stator has a stator core on which a stator coil is wound. The stator coil has a plurality of phase winding to generate a rotary magnetic field.

The rotor core is composed of a soft magnetism material facing an inner circumferential surface of the stator through a magnetic gap. In particular, the rotor core has a plurality of projecting magnetic poles so that a d-axis inductance Ld is larger than a q-axis inductance Lq. The rotor core has a rotor coil wound in q-axis parts formed about a q-axis in an outer circumferential surface of the rotor core.

The synchronous reluctance motor according to the present invention has the rotor coil which is wound in the q-axis parts formed in the rotor core. A direct current is supplied to the rotor coil wound in the q-axis parts. This direct current generates a current magnetic flux in the d-axis parts which serve as the magnetic pole parts formed in the rotor core. The torque of the synchronous reluctance motor is expressed by the following equation:

$$\begin{matrix}T = Ti + Tr \\ = Φ i \cdot Iq + ( Ld - Lq ) \cdot Id \cdot Iq ,\end{matrix}$$

where Ti is a torque (as a current torque) Tr is a reluctance torque, Φi is a current magnetic flux, Iq is a q-axis current, Id is a d-axis current, Ld is a d-axis inductance, and Lq is a q-axis inductance.

That is, the structure of the synchronous reluctance motor according to the present invention generates the torque Ti (hereinafter, also referred to as the “current torque”) using the current magnetic flux Φi in addition to the reluctance torque Tr. The current magnetic flux Φi is generated by the direct current “idc” which is supplied into the rotor coil. The reluctance torque Tr is the inherent torque of the synchronous reluctance motor.

The synchronous reluctance motor according to the present invention has following other features.

First, because of not using any magnets such as permanent magnets, the structure of the synchronous reluctance motor according to the present invention does not need to prevent increasing induced electromotive force caused by the magnetic flux generated by such magnets during a high speed rotation, so that it does not need to generate any magnetic flux Ld·Id in order to eliminate the magnetic flux by increasing the d-axis current Id. This structure of the synchronous reluctance motor according to the present invention can decrease the loss caused by controlling the magnetic field.

The structure of the synchronous reluctance motor according to the present invention needs to produce the direct current “idc” in order to generate the current magnetic flux Φi. This causes an exciting loss. However, it is possible to generate the current magnetic flux Φi of a large value using a small direct current idc flowing into the rotor coil when the rotor coil is composed of small-diameter conductive wires wound in the d-axis parts many times. Therefore the exciting loss does not become large.

Rare earth metal magnets are capable of generating a large amount of magnet flux, but are expensive and not stably supplied to markets. On the other hand, the rotor coil used in the synchronous reluctance motor according to the present invention is cheap in price. Still further, the rotor coil does not have a problem of the rare earth metal magnets which easily increase their temperature.

### BRIEF DESCRIPTION OF THE DRAWINGS

A preferred, non-limiting embodiment of the present invention will be described by way of example with reference to the accompanying drawings, in which:

FIG. 1 is a schematic cross section of a synchronous reluctance motor according to a first embodiment of the present invention in its diameter direction;

FIG. 2 is a schematic cross section of a winding state of a rotor coil wound on a rotor core of the synchronous reluctance motor according to the first embodiment of the present invention;

FIG. 3 is a schematic cross section of a synchronous reluctance motor according to a second embodiment of the present invention in its diameter direction;

FIG. 4 shows a simulation result indicating a relationship between the torque of a rotor current and the rotation speed of the rotor in the synchronous reluctance motor according to the second embodiment shown in FIG. 3;

FIG. 5 is a schematic cross section of a conventional synchronous reluctance motor along its diameter direction; and

FIG. 6 is a schematic cross section of another conventional synchronous reluctance motor along its diameter direction.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Embodiment

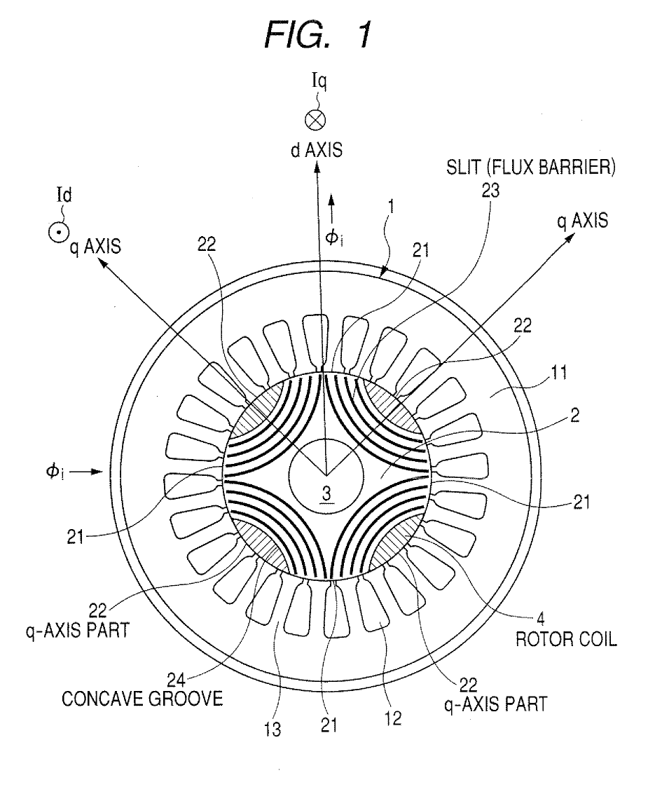

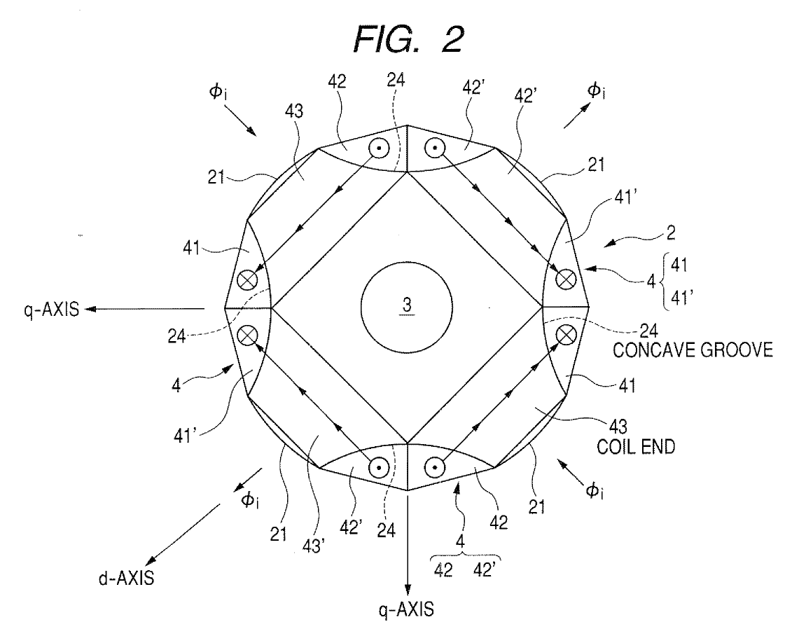

A description will be given of a synchronous reluctance motor according to the first embodiment of the present invention with reference to FIG. 1 and FIG. 2.

FIG. 1 is a schematic cross section of the synchronous reluctance motor according to the first embodiment of the present invention in its diameter direction. The synchronous reluctance motor shown in FIG. 1 has an inner rotor of a radial gap type.

As shown in FIG. 1, the stator 1 is composed of the stator core 11 and a three-phase stator coil (omitted from drawings). The stator core 11 has a cylindrical shape made of laminated magnet steel sheets. The three-phase stator coil is wound on the stator core 11.

Slots 12 and teeth 13 which are alternately formed in the inner circumferential surface of the stator core 11. Flowing a sine-curve current into the three-phase stator coil generates a rotary magnetic field.

The rotor core 2 of a cylindrical shape is composed of laminated magnetic steel sheets which are fixedly adhered to each other and wound about the rotary shaft 3.

Four d-axis parts 21 and four q-axis parts are alternately placed every electrical angle H on the outer circumferential surface of the rotor core 2.

The outer circumferential surface of the rotor core 2 faces the inner circumferential surface of the stator core 11 through small electrical-magnetic gaps.

Four-layer flux barriers 23 (or slits) with lens shape (as space gaps with a circular-arc shape) are formed around the q-axis.

One end of each flux barrier 23 reaches close to the outer circumferential surface of the rotor core 2 in the d-axis part 21, and the other end of each flux barrier 23 reaches close to the outer circumferential surface of the rotor core 2 at its adjacent d-axis part. This structure makes a small q-axis inductance Lq and a large d-axis inductance Ld, and a projecting magnetic pole in the d-axis.

Still further, each concave groove 24 is formed at the corresponding q-axis part 22 in the outer circumferential surface of the rotor core 2.

Each concave groove 24 approximately has a lens shape of a circular arc-shape which is coaxial with the flux barrier 23 of a circular-arc shape.

Each concave groove 24 accommodates a corresponding rotor coil 4. Because each of the concave grooves 24 of a circular-arc shape is approximately formed about the q-axis, the thickness of the rotor coil 4 in the diameter direction has a maximum value at the q-axis and is gradually decreased when the rotor coil 4 is separated from the position of the q-axis.

A description will now be given of the winding state of the rotor coil 4 wound on the rotor core 2 in detail with reference to FIG. 2.

FIG. 2 is a schematic cross section of the winding state of the rotor coil 4 wound on the rotor core 2 of the synchronous reluctance motor according to the first embodiment of the present invention.

As shown in FIG. 2, each concave groove 24 is divided into two parts by the q-axis. That is, each concave groove 24 is composed of one-half divided part and the other-half divided part observed from the q-axis.

A forward conductive part 41 of the rotor coil 4 accommodated in one-half divided part of the concave groove 24 is electrically connected through the coil end 43 with a backward conductive part 42 of the rotor coil 4 accommodated in the other-half divided part of the adjacent concave groove 24 along the circumferential direction of the rotor core 2.

Similarly, a forward conductive part 41′ of tile rotor coil 4 accommodated in the other-half divided part of the concave groove 24 is electrically connected through the coil end 43′ with a backward conductive part 42′ of the rotor coil 4 accommodated in the one-half divided part of the adjacent concave groove 24 along the circumferential direction.

That is, the conductive part of the rotor coil 4 which is accommodated in one-half divided part (or one side) of the N-th concave groove 24 (where, N is a natural number) observed from the q-axis along the circumferential direction of the rotor core 2 is electrically connected with the conductive part of the rotor coil 4 which is accommodated in the other-half divided part (or the other side) of the (N+1)-th of the concave groove 24 observed from the q-axis along the circumferential direction.

Still further, the conductive part of the rotor coil 4 which is accommodated in the other-half divided part (or the other side) of the N-th concave groove 24 observed from the q-axis along the circumferential direction of the rotor core 2 is electrically connected with the conductive part of the rotor coil 4 which is accommodated in one-half divided part (or one side) of the (N−1)-th concave groove 24 observed from the q-axis along the circumferential direction of the rotor core 2. By the way in the structure of the synchronous reluctance motor according to the first embodiment shown in FIG. 1 and FIG. 2, N is four and corresponds to the number of the projecting magnetic poles of the rotor core 2.

This structure of the synchronous reluctance motor according to the first embodiment can reduce the projection amount of each of the coil ends 43 and 43′ in the axial direction.

Next, a description will now be given of the operation of the synchronous reluctance motor according to the first embodiment of the present invention.

A direct current is supplied to the rotor coil 4 placed in the convex grooves 24 formed in the rotor core 2 through well-known components such as a slip ring, a rotary transformer, and a current supply means (not shown). As a result, as shown in FIG. 1 and FIG. 2, the current magnetic-flux Φi is formed in the d-axis direction.

Because the rotor coil 4 is larger in rate of rotation number than the stator coil, the rotor coil 4 has a large inductance. However, no problem occurs because of a direct current flowing mainly in the rotor coil 4. It is thereby possible to generate the current magnetic-flux Φi in addition to the reluctance torque (=(Ld−Lq)Id·Lq) in the synchronous reluctance motor having the above structure according to the first embodiment of the present invention. This structure can realize a synchronous reluctance motor having a large torque with a small size when compared with conventional synchronous reluctance motors. Still further, the synchronous reluctance motor according to the first embodiment of the present invention does not need to control the magnetic flux to decrease during a high speed rotation when compared with the structure of permanent magnet type synchronous motors (PM). The structure of the synchronous reluctance motor according to the present invention can reduce the entire size and manufacturing cost.

### Second Embodiment

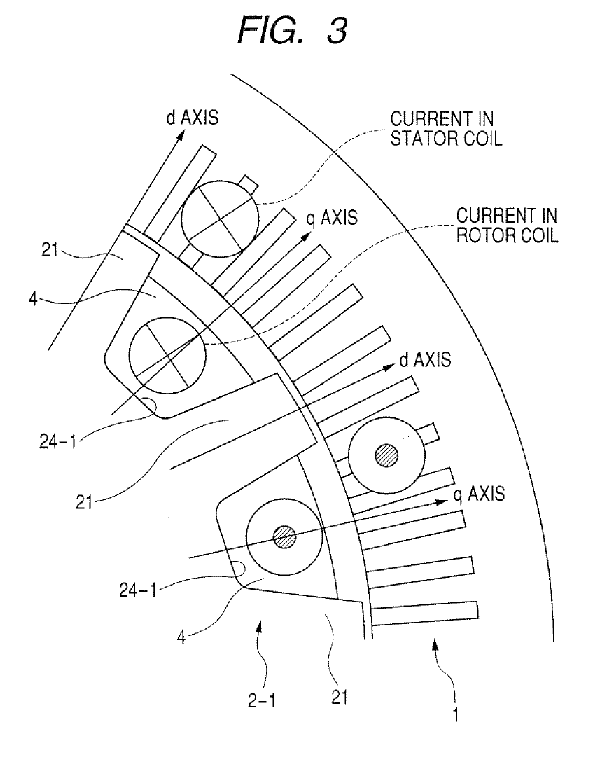

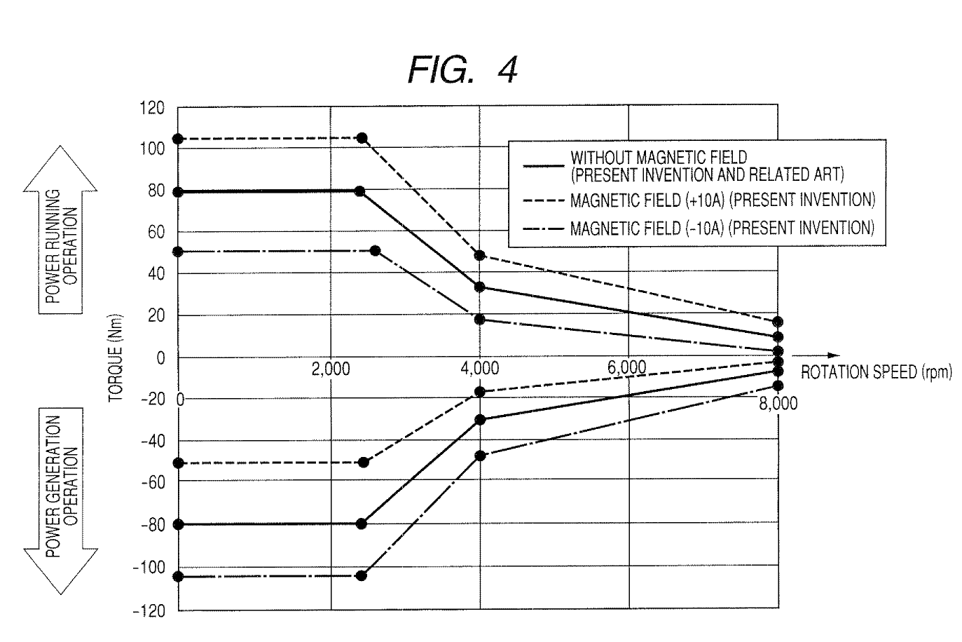

A description will be given of the synchronous reluctance motor according to the second embodiment of the present invention with reference to FIG. 3 and FIG. 4.

FIG. 3 is a schematic cross section of the synchronous reluctance motor of an inner-rotor radial gap type according to the second embodiment of the present invention along its diameter direction. The structure of the synchronous reluctance motor shown in FIG. 3, the number of the magnetic poles in the rotor core 2-1 is larger than that of the rotor core 2 shown in FIG. 1.

### (Structure)

As shown in FIG. 3, there are no flux barriers 23 in the structure of the rotor core 2-1. That is, the flux barriers (or the slits) 23 shown in FIG. 1 are eliminated from the rotor core 2-1. The rotor core 2-1 shown in FIG. 3 has no flux barriers. Each convex groove 24-1 shown in FIG. 3 is larger in depth than the convex groove 24 shown in FIG. 1. Because each concave groove 24-1 has a large depth, this structure makes it possible to easily wind the rotor coil 4 in the convex groove 24-1, and to suppress escaping of the rotor coil 4 from the rotor core 2-1 by centrifugal force when the rotor rotates at a high rotation speed.

### (Simulation Result)

A description will now be given of a simulation result of the synchronous reluctance motor according to the present invention and a comparison example with reference to FIG. 4.

FIG. 4 shows the simulation result indicating a relationship between the torque of a rotor current and the rotation speed of the rotor in the synchronous reluctance motor according to the second embodiment. The simulation was performed under following conditions (a), (b), and (c):

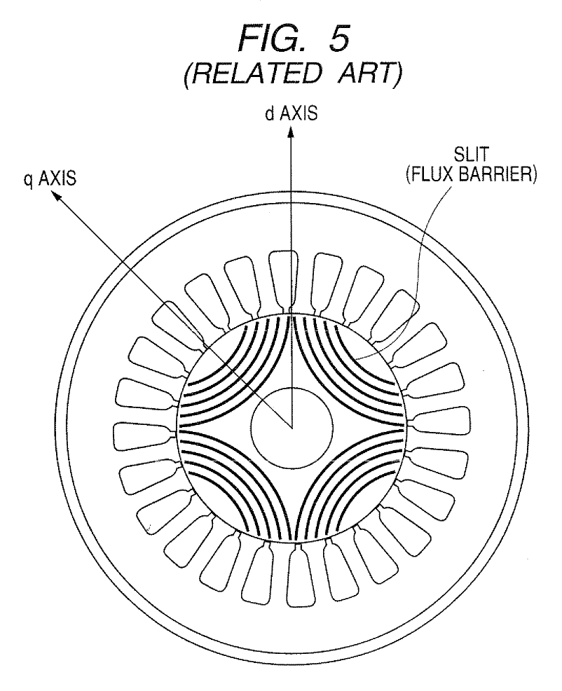

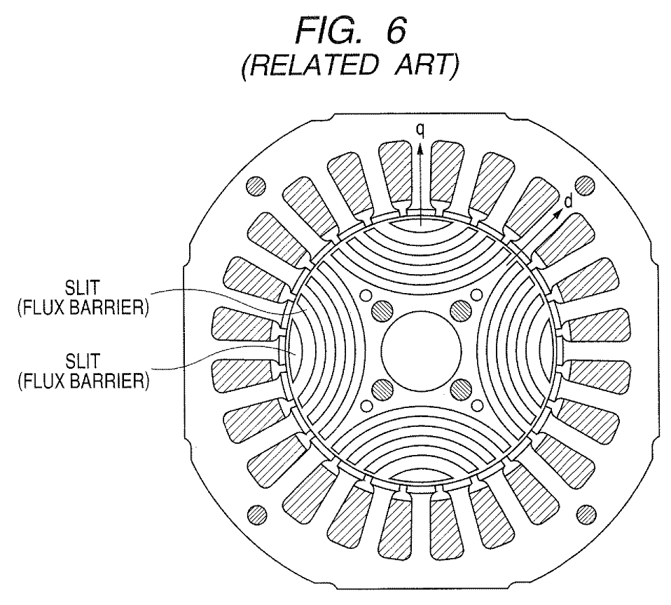

(a) Without magnetic field indicated by the solid lines shown in FIG. 4. This case corresponds to the related art shown in FIG. 5 and FIG, 6 because the structure of the related art shown in FIG. 5 and FIG. 6 has no rotor coil. Further, this case also corresponds to the present invention shown in FIG. 3 without any current to be supplied to the rotor coil 4 shown in FIG. 3;

(b) With magnetic field indicated by the dashed lines in FIG. 4. Current of 10 amperes is supplied in a forward direction into the rotor coil 4 shown in FIG. 3 according to the present invention; and

(c) With magnetic field indicated by the alternate long and short dash lines in FIG. 3. Reverse current of 10 amperes is supplied in a backward direction into the rotor coil 4 shown in FIG. 3 according to the present invention.

As clearly understood from the simulation result shown in FIG. 4, the structure of the synchronous reluctance motor according to the present invention can increase the torque (Nm). It is possible to change the magnitude of the torque by adjusting the magnitude of current to be supplied into the rotor coil 4.

On the other hand, the structure of the conventional synchronous reluctance motor shown in FIG. 5 or FIG. 6 cannot change the torque of the synchronous reluctance motor at a same rotation speed (rpm) because a fixed current is supplied to the rotor coil.

### (Other Features and Effects of the Present Invention)

In the synchronous reluctance motor according to another aspect of the present invention, the d-axis parts about the d-axis and the q-axis parts about the q-axis are alternately formed along the circumferential direction in the outer circumferential surface of the rotor core. The rotor coil is wound in convex grooves formed in the q-axis parts. This structure does not increase the entire size of the synchronous reluctance motor even if the rotor coil is added into the rotor core. Further, this structure does not deteriorate the projecting magnetic pole characteristics. In particular, because the formation of the convex parts in the rotor core can decrease the q-axis inductance Lq, it is possible to increase the value (Ld−Lq), and thereby to increase the reluctance torque of the synchronous reluctance motor.

In the synchronous reluctance motor according to another aspect of the present invention, the rotor core has a plurality of flux barriers which are formed in the inside area of the rotor core observed from the convex grooves, and the flux barriers reach the d-axis parts formed between the adjacent convex grooves along the circumferential direction of the rotor core. This structure can further increase the reluctance torque of the synchronous reluctance motor.

In the synchronous reluctance motor according to another aspect of the present invention, the rotor coil has a cross sectional shape in the diametrical direction of the rotor coil so that the rotor coil has a maximum diametrical width at the q-axis position, and the diametrical width of the rotor coil is gradually decreased according to be separated from the q-axis. This structure supports the outer circumferential part of the rotor core approximately in the cylindrical surface, and increases the turning number of the rotor coil in the d-axis parts.

In the synchronous reluctance motor according to another aspect of the present invention, the rotor coil, wound in one side of the N-th concave groove observed from the q-axis along the circumferential direction of the rotor core is electrically connected with the rotor coil, wound in the other side of the (N+1)-th concave groove observed from the q-axis along the circumferential direction of the rotor core. The rotor coil, wound in the other side of the N-th concave groove observed from the q-axis along the circumferential direction of the rotor core is electrically connected with the rotor coil, wound in one side of the (N−1)-th concave groove observed from the q-axis along the circumferential direction of the rotor core, where N is a natural number and designates a magnetic pole number. This structure can decrease the coil end of the rotor core projected from the surface of the rotor core in the axial direction of the rotor core.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A synchronous reluctance motor comprising:
a stator having a stator core on which a stator coil is wound, the stator coil comprising a plurality of phase windings to generate a rotary magnetic field; and
a rotor core composed of a soft magnetism material facing an inner circumferential surface of the stator through a magnetic gap, the rotor core having a plurality of projecting magnetic poles so that a d-axis inductance Ld is larger than a q-axis inductance Lq, and the rotor core having a rotor coil wound in q-axis parts formed about a q-axis in an outer circumferential surface of the rotor core.

2. The synchronous reluctance motor according to claim 1, wherein d-axis parts about the d-axis and the q-axis parts about the q-axis are alternately formed, along the circumferential direction of the rotor core, in the outer circumferential surface of the rotor core, and the rotor coil is wound in convex grooves formed in the q-axis parts.

3. The synchronous reluctance motor according to claim 2, wherein the rotor core has a plurality of flux barriers which are formed in the inside area of the rotor core observed from the convex grooves, and the flux barriers reach the d-axis parts formed between the adjacent convex grooves along the circumferential direction of the rotor core.

4. The synchronous reluctance motor according to claim 2, wherein the rotor coil has a cross sectional shape in the diametrical direction of the rotor coil so that the rotor coil has a maximum diametrical width at the q-axis position, and the diametrical width of the rotor coil is gradually decreased according to be separated from the q-axis.

5. The synchronous reluctance motor according to claim 4, wherein the rotor coil, wound in one side of a N-th concave groove observed from the q-axis along the circumferential direction of the rotor core is electrically connected with the rotor coil, wound in the other side of a (N+1)-th concave groove observed from the q-axis along the circumferential direction of the rotor core, and
the rotor coil, wound in the other side of the N-th concave groove observed from the q-axis along the circumferential direction of the rotor core is electrically connected with the rotor coil, wound in one side of a (N−1)-th concave groove observed from the q-axis along the circumferential direction of the rotor core, where N is a natural number and designates a magnetic pole number.

6. The synchronous reluctance motor according to claim 5, wherein N is four.

7. The synchronous reluctance motor according to claim 5, wherein the rotor core has no flux barrier.
